(19) United States
(12) Patent Application Publication
(10) Pub. No.: US 2023/0391004 A1
(43) Pub. Date: Dec. 7, 2023

(54) Three dimensional printer

(71) Applicant: Winsun technology INC., Irvine, CA (US)

(72) Inventor: Yihe MA

(73) Assignee: Winsun technology INC., Irvine, CA (US)

(21) Appl. No.: 18/331,016

(22) Filed: Jun. 7, 2023

(30) Foreign Application Priority Data
Jun. 7, 2022 (CN) 202221395058.7

(51) Int. Cl. B29C 64/245; B33Y 30/00

(52) U.S. Cl. CPC B29C 64/245; B33Y 30/00

(57) ABSTRACT

The present invention to the field of 3D printers, especially a truss-type 3D printer. It addresses the problem that existing printers only have printing functionality and cannot handle and lift construction materials without additional equipment. The solution disclosed herein is a hoisting elevator platform comprising two standard sections of column extension, two standard sections of reinforcement, a standard section of main beam, two standard sections of the X-axis, two hoisting elevator platforms, gantry crane components, and cantilever crane components. The hoisting elevator platforms are slidably installed on the corresponding standard sections of column extension. The present invention disclosed a printer itself having climbing capabilities, allowing for printing in high-rise buildings. It can also extend horizontally with multiple printers in parallel. The printer is equipped with a cantilever crane to handle materials on-site, meeting the rigid requirements of height variations.

### TECHNICAL FIELD

The present application relates to the technical field of three-Dimensional (3D) printers, particularly a truss-type 3D printer.

### BACKGROUND

A 3D printer generally refers to a three-dimensional printer, which is a rapid prototyping process that creates three-dimensional models by layer-by-layer stacking. However, existing printers only have printing functionality and cannot handle construction materials without additional equipment.

### SUMMARY OF THE INVENTION

The purpose of the present patent application is to solve the disadvantages of the prior art and provide a truss-type 3D printer.

To achieve the above purpose, the present patent application adopts the following technical solution.

A truss-type 3D printer disclosed herein, comprises two standard sections of column extension, two standard sections of reinforcement, a standard section of the main beam, two standard sections of the X-axis, two hoisting elevator platforms, gantry crane assemblies, and cantilever crane assemblies. The hoisting elevator platforms are slidably installed on the corresponding standard sections of column extension. The hoisting elevator platforms are fixedly connected to decoration suspended scaffolds on both sides, and the bottom ends of both decoration suspended scaffolds are fixedly equipped with support tension rods. One end of the support tension rods is fixedly installed on the hoisting elevator platforms. Both hoisting elevator platforms are fixedly equipped with transmission installation plates, and both standard sections of column extension are fixedly equipped with linear guide rails. The transmission installation plates are slidably installed on the corresponding linear guide rails. The standard sections of the X-axis are fixedly installed on the corresponding transmission installation plates, and the standard sections of reinforcement are fixedly installed between the two standard sections of the X-axis. The standard section of the main beam is fixedly installed between the two standard sections of the X-axis. The top of both standard sections of column extension is fixedly equipped with lifting standard sections. The cantilever crane assemblies are positioned on the lifting standard sections, and the same gantry frame is fixedly installed on both lifting standard sections. The gantry crane assemblies are positioned on the gantry frame. The standard sections of reinforcement are slidably equipped with roller mounting brackets, and servo motors are fixedly installed on the roller mounting brackets. The output shaft of the servo motors is fixedly connected to a rotating print head.

Specifically, the cantilever crane assembly comprises a rotary table, a cantilever installation plate, a cantilever main beam, a cantilever crane transmission assembly, and a heavy-duty hook. The top of the lifting standard sections is fixedly equipped with a rotary table, and the rotary table is fixedly equipped with a cantilever installation plate. The cantilever installation plate is fixedly equipped with a cantilever main beam.

Specifically, the cantilever main beam is fixedly equipped with truss tension rods, and one end of the truss tension rods is fixedly installed on the cantilever installation plate. The cantilever main beam is equipped with a cantilever crane transmission assembly, and the cantilever crane transmission assembly is equipped with a heavy-duty hook.

Specifically, a plurality of truss reinforcement ribs are fixedly installed on the standard sections of column extension.

Specifically, a plurality of wall-attached tension rods are fixedly installed on the standard sections of column extension.

Specifically, the same X-axis reinforced tension rod is fixedly installed on the two standard sections of the X-axis.

Specifically, the bottom of both standard sections of column extension is fixedly equipped with column reinforcement ribs.

Compared to the prior art, the advantageous effects of the present patent application are as follows:

(1) The present patent application provides a truss-type 3D printer that utilizes column-connected beams on the basis of the original truss structure. It incorporates a designed moving track for gantry crane operation. This printer allows for the lifting and handling of various materials while printing. When not in printing mode, it can be used as a standalone gantry crane, achieving a greater lifting distance, and meeting the material circulation and handling needs within the building.

(2) The present patent application provides a truss-type 3D printer that has climbing capabilities, allowing for printing in high-rise buildings. It can also extend horizontally with multiple printers in parallel. The printer is equipped with a cantilever crane to handle materials on-site, meeting the rigid requirements of height variations. It realizes a printer for high-rise and large-span buildings.

### DESCRIPTION OF THE DRAWINGS

In order to provide a clearer description of the embodiments of the present patent application or the technical solutions in the prior art, the accompanying drawings used in the embodiments or descriptions of the prior art will be briefly introduced below. It is apparent that the accompanying drawings described below are merely illustrative examples. The structures, proportions, sizes, etc., depicted in this specification are only used to assist in explaining the disclosed content of the specification, allowing those skilled in the art to understand and read, and should not be used to limit the conditions that can be implemented in the present patent application. Therefore, any modification of the structure, change in the proportional relationship, or adjustment in size of the device does not have any substantial technical significance.

FIG. 1 is a perspective structural diagram of a truss-type 3D printer proposed in the present patent application.

FIG. 2 is a front view structural diagram of a truss-type 3D printer proposed in the present patent application.

FIG. 3 is a structural diagram of section A of a truss-type 3D printer proposed in the present patent application.

FIG. 4 is a structural diagram of section B of a truss-type 3D printer proposed in the present patent application.

FIG. 5 is a structural diagram of section C of a truss-type 3D printer proposed in the present patent application.

In the figures: 1. standard section of column extension; 2. standard section of reinforcement; 3. standard section of the main beam; 4. standard section of the X-axis; 5. X-axis reinforced tension rod; 6. truss reinforcement rib; 7. column reinforcement rib; 8. wall-attached tension rod; 9. hoisting elevator platform; 10. decoration suspended scaffold; 11. support tension rod for suspended scaffold; 12. gantry frame; 13. gantry crane assembly; 14. lifting standard section; 15. transmission installation plate; 16. linear guide rail; 17. roller mounting bracket; 18. rotating print head; 19. servo motor; 20. rotary table; 21. cantilever installation plate; 22. truss tension rod; 23. cantilever main beam; 24. cantilever crane transmission assembly; 25. heavy-duty hook.

### DETAIL EMBODIMENTS

The following specific embodiments describe the embodiments of the present patent application. Those skilled in the art can easily understand other advantages and effects of the present patent application based on the disclosed content of this specification. Obviously, the described embodiments are only part of the embodiments of the present patent application, not all embodiments. Based on the embodiments in the present patent application, all other embodiments obtained by those skilled in the art without inventive labor are within the scope of protection of the present patent application.

In the description of the present invention, it should be understood that the terms “center”, “longitudinal”, “lateral”, “length”, “width”, “thickness”, “upper”, “lower”, “front”, “Back”, “Left”, “Right”, “Vertical”, “Horizontal”, “Top”, “Bottom”, “Inner”, “Outer”, “Clockwise”, “Counterclockwise”, “Axial”, The orientation or positional relationship indicated by “circumferential direction”, “radial direction”, etc. is based on the orientation or positional relationship shown in the accompanying drawings, and is only for the convenience of describing the present invention and simplifying the description, rather than indicating or implying the indicated device or Elements must have a specific orientation, be constructed and operate in a specific orientation, and therefore should not be construed as a limitation of the present invention.

Furthermore, terms such as “first” and “second” are used only for descriptive purposes and should not be understood as indicating or implying relative importance or implying the quantity of the indicated technical features. Thus, features with “first” or “second” can explicitly or implicitly include one or more of such features. In the description of the present patent application, the term “multiple” means two or more, unless otherwise specifically and explicitly specified.

In the present patent application, unless otherwise specifically defined and limited, terms such as “installation,” “connected,” “connected to,” “fixed,” and the like should be broadly interpreted. For example, it can refer to fixed connections, detachable connections, or integral connections. It can be a mechanical connection or an electrical connection. It can be a direct connection or an indirect connection through an intermediate medium. It can also refer to internal connections between two components. Those skilled in the art can understand the specific meanings of the aforementioned terms in the present patent application based on specific circumstances.

In the present patent application, unless otherwise specifically defined and limited, the term “above” or “below” between the first feature and the second feature can include direct contact between the first and second features, or it can include contact between the first and second features through another feature between them. Additionally, the term “above,” “on top of,” and “on” with respect to the second feature can include the first feature being directly above or diagonally above the second feature, or it can simply indicate that the horizontal height of the first feature is higher than that of the second feature. The term “below,” “under,” and “beneath” with respect to the second feature can include the first feature being directly below or diagonally below the second feature, or it can simply indicate that the horizontal height of the first feature is lower than that of the second feature.

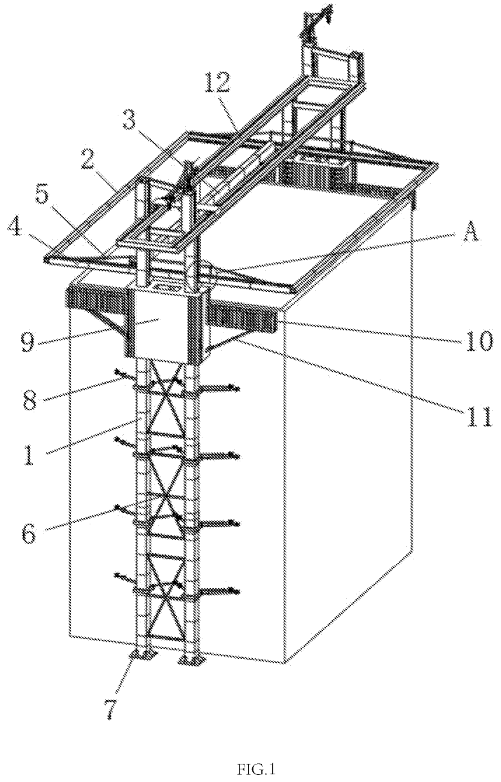

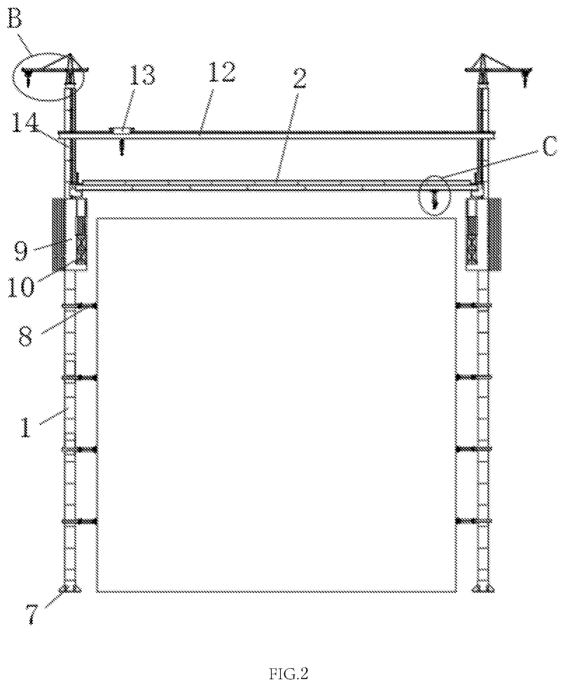

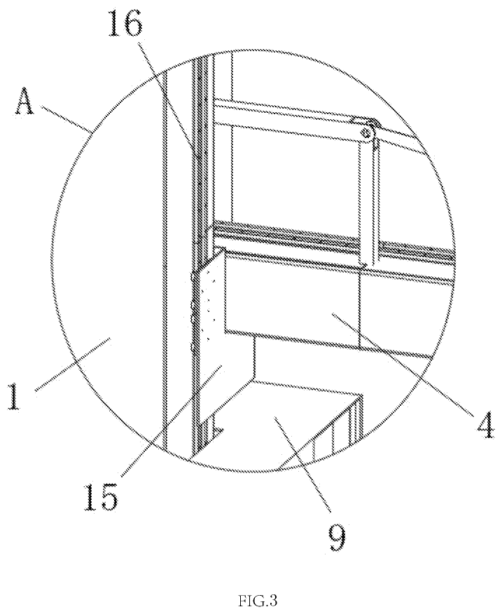

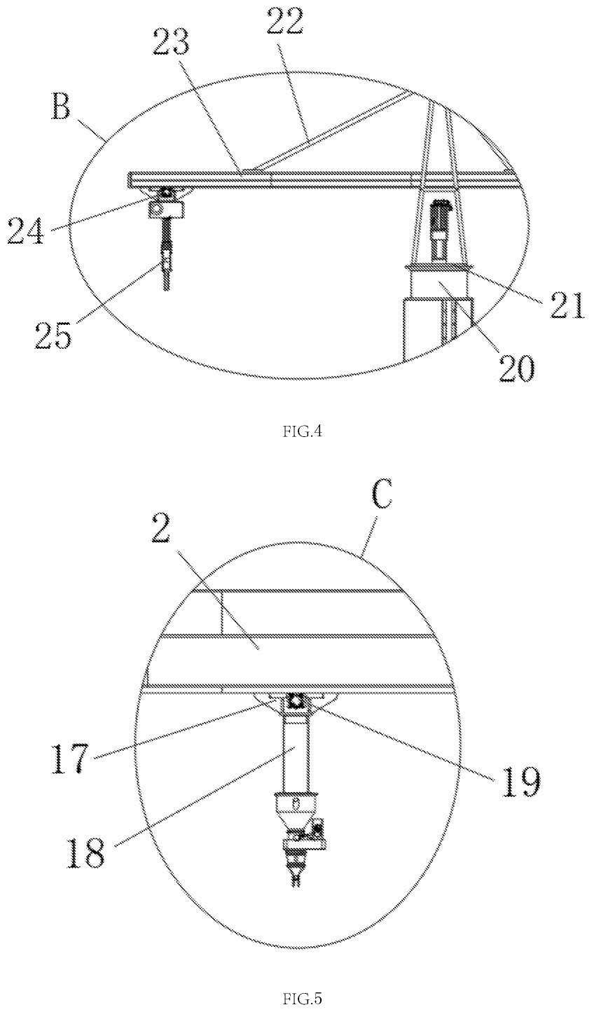

Referring to FIGS. 1-4, a truss-type 3D printer is provided, comprising two standard sections of column extension 1, two standard sections of reinforcement 2, a standard section of the main beam 3, two standard sections of the X-axis 4, two hoisting elevator platforms 9, a gantry crane assembly 13, and a cantilever crane assembly. The hoisting elevator platforms 9 are slidably installed on the corresponding standard sections of column extension 1. Both hoisting elevator platforms 9 are fixedly equipped with transmission installation plates 15. Both standard sections of column extension 1 are fixedly equipped with linear guide rails 16. The transmission installation plates 15 are slidably installed on the corresponding linear guide rails 16. The standard sections of the X-axis 4 are fixedly installed on the corresponding transmission installation plates 15. The standard sections of reinforcement 2 are fixedly installed between the two standard sections of the X-axis 4. The standard section of the main beam 3 is fixedly installed between the two standard sections of the X-axis 4. The tops of both standard sections of column extension 1 are fixedly equipped with lifting standard sections 14. The cantilever crane assembly is positioned on the lifting standard sections 14. Both lifting standard sections 14 are fixedly equipped with the same gantry frame 12. The gantry crane assembly 13 is positioned on the gantry frame 12. The standard sections of reinforcement 2 are slidably equipped with roller mounting brackets 17. The roller mounting brackets 17 are fixedly equipped with servo motors 19. The output shaft of the servo motors 19 is fixedly connected to rotating print heads 18.

In this embodiment, the cantilever crane assembly comprises a rotating platform 20, a cantilever mounting plate 21, a cantilever main beam 23, a cantilever crane transmission component 24, and a heavy-duty hook 25. The top of the lifting standard sections 14 is fixedly equipped with the rotating platform 20, and the rotating platform 20 is fixedly equipped with the cantilever mounting plate 21. The cantilever mounting plate 21 is fixedly equipped with the cantilever main beam 23, which is further fixedly equipped with truss rods 22. One end of the truss rods 22 is fixedly installed on the cantilever mounting plate 21. The cantilever main beam 23 is equipped with the cantilever crane transmission component 24, and the cantilever crane transmission component 24 is equipped with the heavy-duty hook 25.

In this embodiment, the hoisting elevator platform 9 is fixedly connected with decoration baskets 10 on both sides. The bottoms of both decoration baskets 10 are fixedly equipped with support rods 11, and one end of the support rods 11 is fixedly installed on the hoisting elevator platform 9.

In this embodiment, several truss reinforcement bars 6 are fixedly installed on the standard sections of column extension 1.

In this embodiment, several wall-mounted rods 8 are fixedly installed on the standard sections of column extension 1.

In this embodiment, the bottom ends of the two standard sections of column extension 1 are both fixedly equipped with column reinforcement bars 7.

In this embodiment, the same X-axis reinforcement rod 5 is fixedly installed on the two X-axis standard sections 4.

In this embodiment, the lifting and hoisting platform is controlled by the lifting mechanism to ascend and descend on the standard sections of column extension 1. The gantry crane component 13 can perform gantry crane operations on the gantry frame 12. The cantilever crane transmission component 24 can control the heavy-duty hook 25 for cantilever crane operations. The rotating print head 18 can move on the reinforcement standard section 2 with the assistance of the roller mounting bracket 17 and perform 3D printing operations. The proposed structure utilizes the column as a connection beam on the existing truss, designed with a mobile track for gantry crane operations. It allows for the lifting of various materials during printing and can be used independently as a gantry crane, enabling a larger lifting distance to meet the internal material handling and lifting needs of buildings. The printer itself has climbing capabilities, enabling printing in high-rise buildings. It can also be horizontally extended in parallel with multiple units for printing. The addition of a cantilever crane meets the on-site material handling requirements, and the rigidity demands of height variations, enabling printing in high-rise and large-span buildings.

The technical advancements achieved by the present patent application over the prior art are as follows: The printer itself has climbing capabilities, enabling printing in high-rise buildings. It can be horizontally extended in parallel with multiple units for printing. The addition of a cantilever crane meets the on-site material handling requirements and the rigidity demands of height variations, enabling printing in high-rise and large-span buildings. It can also be used independently as a gantry crane, enabling a larger lifting distance to meet the internal material handling and lifting needs of buildings.

I claim:

1. A truss-type 3D printer, comprising
two standard sections of column extension (1),
two standard sections of reinforcement (2),
a standard section of the main beam (3),
two standard sections of the X-axis (4),
two hoisting elevator platforms (9),
gantry crane assemblies (13), and cantilever crane assemblies;
wherein the hoisting elevator platforms (9) are slidably installed on the corresponding standard sections of column extension (1);
both hoisting elevator platforms (9) are fixedly equipped with transmission installation plates (15), and both standard sections of column extension (1) are fixedly equipped with linear guide rails (16);
wherein the transmission installation plates (15) are slidably installed on the corresponding linear guide rails (16); the standard sections of the X-axis (4) are fixedly installed on the corresponding transmission installation plates (15), and the standard sections of reinforcement (2) are fixedly installed between the two standard sections of the X-axis (4); the standard section of the main beam (3) is fixedly installed between the two standard sections of the X-axis (4); the top of both standard sections of column extension (1) is fixedly equipped with lifting standard sections (14), and the cantilever crane assemblies are positioned on the lifting standard sections (14); the same gantry frame (12) is fixedly installed on both lifting standard sections (14), and the gantry crane assemblies (13) are positioned on the gantry frame (12), the standard sections of reinforcement (2) are slidably equipped with roller mounting brackets (17), and servo motors (19) are fixedly installed on the roller mounting brackets (17), the output shaft of the servo motors (19) is fixedly connected to a rotating print head (18).

2. The truss-type 3D printer of claim 1, wherein the cantilever crane assembly comprises a rotary table (20), a cantilever installation plate (21), a cantilever main beam (23), a cantilever crane transmission assembly (24), and a heavy-duty hook (25); the top of the lifting standard section (14) is fixedly equipped with a rotary table (20), and a cantilever installation plate (21) is fixed mounted on top of the rotary table (20); the cantilever installation plate (21) is fixedly equipped with a cantilever main beam (23).

3. The truss-type 3D printer of claim 1, wherein the cantilever main beam (23) is fixedly equipped with truss tension rods (22), and one end of the truss tension rods (22) is fixedly installed on the cantilever installation plate (21). The cantilever main beam (23) is equipped with a cantilever crane transmission assembly (24), and the cantilever crane transmission assembly (24) is equipped with a heavy-duty hook (25).

4. The truss-type 3D printer of claim 1, wherein a plurality of truss reinforcement ribs (6) are fixedly installed on the standard sections of column extension (1).

5. The truss-type 3D printer of claim 1, wherein a plurality of wall-attached tension rods (8) are fixedly installed on the standard sections of column extension (1).

6. The truss-type 3D printer of claim 1, wherein the two standard sections of the X-axis (4) are fixedly equipped with the same X-axis reinforced tension rod (5).

7. The truss-type 3D printer of claim 1, wherein bottom ends of both standard sections of column extension (1) are fixedly equipped with column reinforcement ribs (7).

8. The truss-type 3D printer of claim 1, wherein both sides of the hoisting elevator platforms (9) are fixedly connected to decoration suspended scaffolds (10). The bottom ends of both decoration suspended scaffolds (10) are fixedly equipped with support tension rods (11), and one end of the support tension rods (11) is fixedly installed on the hoisting elevator platforms (9).
